(19) United States
(12) Patent Application Publication
(10) Pub. No.: US 2012/0054501 A1
(43) Pub. Date: Mar. 1, 2012

(54) IMAGE PROCESSING APPARATUS

(75) Inventor: Hiroyuki KATO, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/216,609

(22) Filed: Aug. 24, 2011

Related U.S. Application Data
(60) Provisional application No. 61/376,969, filed on Aug. 25, 2010.

(51) Int. Cl. G06F 12/14

(52) U.S. Cl. 713/193; 711/E12.092

(57) ABSTRACT

According to one embodiment, an image processing apparatus includes a first nonvolatile storage medium, a second nonvolatile storage medium, a generation unit, and a control unit. The generation unit is configured to generate an encrypting key for encrypting image data. The control unit is configured to store the encrypting key on the first nonvolatile storage medium, and store an encrypting key which copies the encrypting key on the second nonvolatile storage medium.

### CROSS-REFERENCE TO RELATED APPLICATION

This application is based upon and claims the benefit of priority from Provisional Application No. 61/376,969, filed on Aug. 25, 2010, the entire contents of which are incorporated herein by reference.

### FIELD

Embodiments described herein relate generally to an image processing apparatus which stores an encrypting key for encrypting image data.

### BACKGROUND

In the related art, there is a proposal for a safe image processing apparatus which prevents leakage of image data generated by a user. The image processing apparatus generates an encrypting key unique to the apparatus in order to encrypt the image data. The image processing apparatus stores the encrypting key on, for example, an embedded nonvolatile storage medium. The image processing apparatus encrypts the image data using the encrypting key and stores the encrypted image data on, for example, an HDD. In addition, the image processing apparatus decrypts the encrypted image data stored on the HDD, using the encrypting key.

However, in the image processing apparatus, if failure or damage occurs in the nonvolatile storage medium storing the encrypting key, the encrypting key may not be used. That is to say, the encrypted image data stored on the HDD may not be restored (decrypted).

### BRIEF DESCRIPTION OF THE DRAWINGS

FIG. 1 is a block diagram of an image processing apparatus according to an embodiment.

FIG. 2 is a flowchart illustrating duplexing of an encrypting key according to the embodiment.

FIG. 3 is a flowchart illustrating copying of an encrypting key according to the embodiment.

FIG. 4 is a flowchart illustrating a backup of an encrypting key according to the embodiment.

FIG. 5 is a flowchart illustrating restoring of an encrypting key of the embodiment.

FIG. 6 is a flowchart illustrating a damage detection of an encrypting key according to the embodiment.

### DETAILED DESCRIPTION

In general, according to one embodiment, there is provided an image processing apparatus including a first nonvolatile storage medium, a second nonvolatile storage medium, a generation unit, and a control unit. The generation unit is configured to generate an encrypting key for encrypting image data. The control unit is configured to store the encrypting key on the first nonvolatile storage medium, and store an encrypting key which copies the encrypting key on the second nonvolatile storage medium.

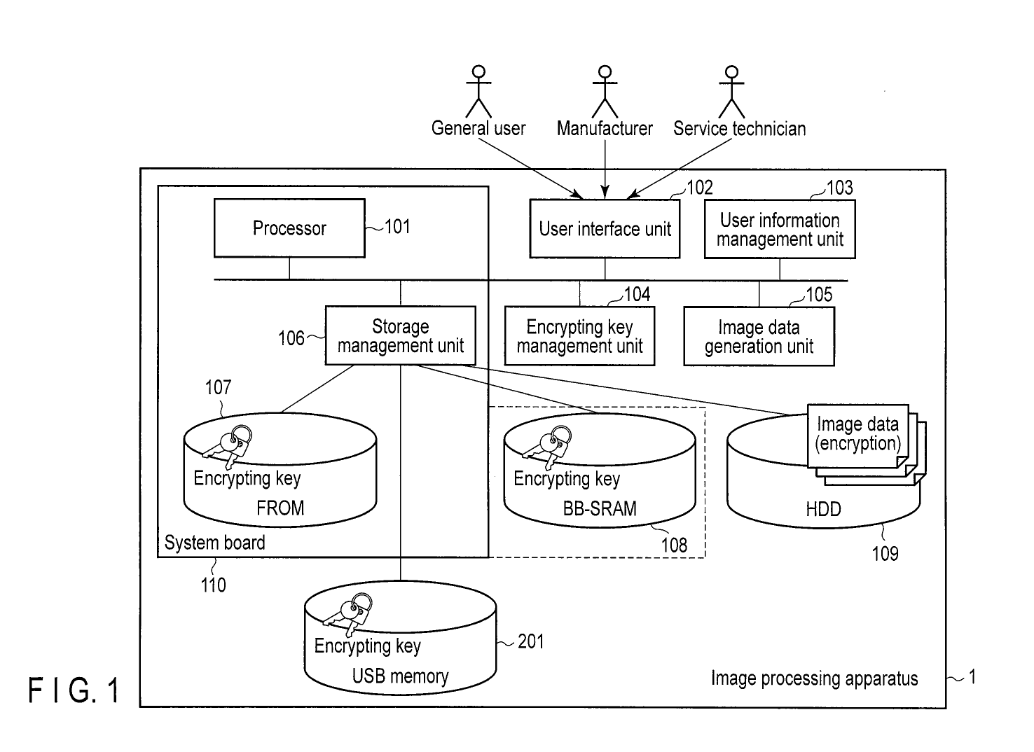

Hereinafter, embodiments will be described with reference to the drawings. FIG. 1 is a block diagram of an image processing apparatus 1 according to an embodiment. The image processing apparatus 1 is, for example, an MFP (Multi-Function Peripheral). The image processing apparatus 1 includes a processor 101, a user interface unit 102, a user information management unit 103, an encrypting key management unit 104, an image data generation unit 105, a storage management unit 106, an FROM (Flash-ROM) 107, a BB-SRAM (Battery Backup-SRAM) 108, and an HDD (Hard Disk Drive) 109. The respective units are connected to each other via a bus.

The processor 101 gives instructions for execution of processes to the respective units. The user interface unit 102 provides a user interface function. For example, the user interface unit 102 is a touch panel having a display portion displaying various kinds of information and an input portion which can input necessary matter.

The user information management unit 103 manages a username and a password for each user. The encrypting key management unit 104 manages generation, removal, and the like of an encrypting key. In addition, the encrypting key management unit 104 encrypts and decrypts image data using the encrypting key. The image data generation unit 105 generates image data from an original document which is read by a scanner (not shown). The storage management unit 106, the FROM 107, and the BB-SRAM 108 are installed in a system board 110 so as not to be detachable. The system board 110 can be connected to the HDD 109 and a USB memory 20. The storage management unit 106 manages the respective nonvolatile storage media connected to the system board 110.

The FROM 107 is a fixed nonvolatile storage medium. The fixed nonvolatile storage medium is a storage device fixed to the system board 110, and indicates a medium which is not detachable from the system board 110. The FROM 107 stores an encrypting key generated by the encrypting key management unit 104. In addition, in the embodiment, other fixed nonvolatile storage media may be employed instead of the FROM 107.

The BB-SRAM 108 is a semi-fixed nonvolatile storage medium. The semi-fixed nonvolatile storage medium is a storage device connected to the system board 110 via a vendor-specific connector, and indicates a medium which is detachable from the system board 110. The BB-SRAM 108 stores the encrypting key generated by the encrypting key management unit 104. In addition, a process where the processor 101 stores an encrypting key on the BB-SRAM 108 will be described later. Further, in the embodiment, other semi-fixed nonvolatile storage media may be employed instead of the BB-SRAM 108.

The HDD 109 is a large-capacity nonvolatile storage medium. The large-capacity nonvolatile storage medium is a storage device which is detachable from the system board 110, and indicates a device having a large storage capacity. The HDD 109 stores image data which is encrypted by the processor 101 using the encrypting key. In the embodiment, other large-capacity nonvolatile storage media may be employed instead of the HDD 109.

The USB memory 20 is an attachable and detachable nonvolatile storage medium. The attachable and detachable nonvolatile storage medium is a storage device which can be connected to the system board 110 via a standard connector, and is attachable and detachable to and from the system board 110. The USB memory 20 stores the encrypting key generated by the encrypting key management unit 104. In addition, a process where the processor 101 stores an encryption key on the USB memory 20 will be described later. Further, in the embodiment, other attachable and detachable nonvolatile storage media may be employed instead of the USB memory 20.

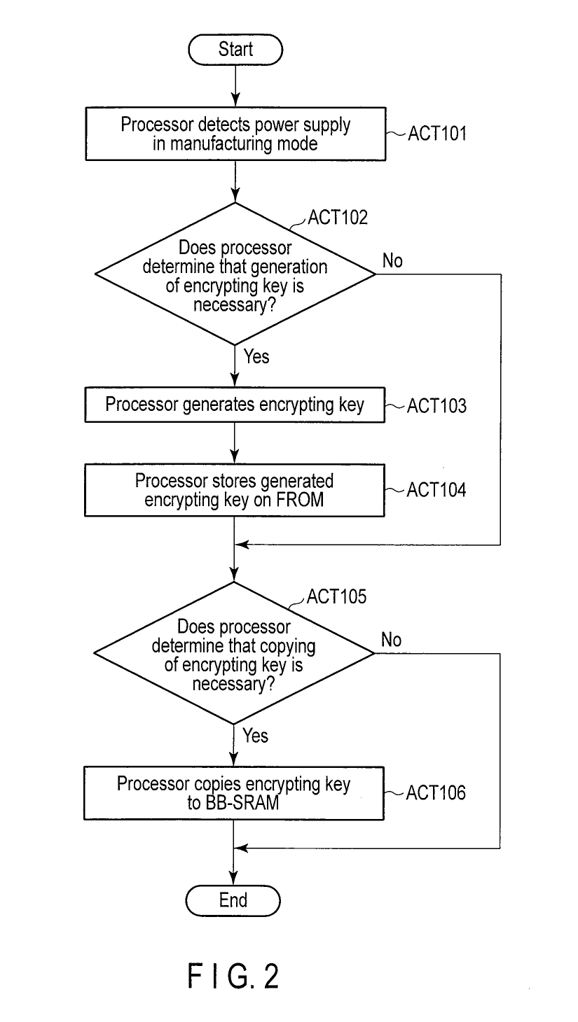

Next, duplexing of an encrypting key will be described. Here, storing an encrypting key on the FROM 107 and the BB-SRAM 108 is referred as duplexing of an encrypting key. FIG. 2 is a flowchart illustrating duplexing of an encrypting key. For example, as initial settings when the image processing apparatus 1 is manufactured, the processor 101 executes the processes of the flowchart shown in FIG. 2.

First, the processor 101 detects power supply in a manufacturing mode (Act 101). Here, the manufacturing mode is a mode which allows a manufacturer to perform various kinds of settings when the image processing apparatus 1 is manufactured. In Act 101, the processor 101 detects the power supply in the manufacturing mode when the manufacturer selects the manufacturing mode from the user interface unit 102 and then supplies power. Next, the processor 101 determines whether or not generation of an encrypting key is necessary (Act 102). In Act 102, the processor 101 detects, for example, an initial activation of the image processing apparatus 1, and determines that the generation of an encrypting key is necessary if detecting that an encrypting key is not stored on the FROM 107.

If the processor 101 determines that the generation of an encrypting key is necessary (Act 102, Yes), the processor 101 generates an encrypting key in the encrypting key management unit 104 (Act 103). For example, the processor 101 uses a apparatus serial number of the image processing apparatus 1 as a seed, and generates an encrypting key unique to the image processing apparatus 1 using an encryption algorithm such as AES256. Next, the processor 101 stores the generated encrypting key on the FROM 107 (Act 104). Thereafter, the processor 101 determines whether or not copying of the encrypting key to the BB-SRAM 108 is necessary (Act 105). Then, in a case where the processor 101 determines that the generation of an encrypting key is not necessary (Act 102, No) as well, the processor 101 performs the process in Act 105. In Act 105, for example, if detecting the initial activation of the image processing apparatus 1 and detecting that the encrypting key is not stored on the BB-SRAM 108, the processor 101 determines that the copying of the encrypting key to the BB-SRAM 108 is necessary.

If the processor 101 determines that the copying of the encrypting key to the BB-SRAM 108 is necessary (Act 105, Yes), the processor 101 copies the encrypting key stored on the FROM 107 to the BB-SRAM 108 (Act 106). If the processor 101 determines that the copying of the encrypting key to the BB-SRAM 108 is not necessary (Act 105, No), the processor 101 finishes the processes.

In addition, although, in FIG. 1, the example where the encrypting key stored on the FROM 107 is copied to the BB-SRAM 108 is described, the processor 101 may store the encrypting key on the BB-SRAM 108 in Act 104, and may copy the encrypting key stored on the BB-SRAM 108 to the FROM 107 in Act 106.

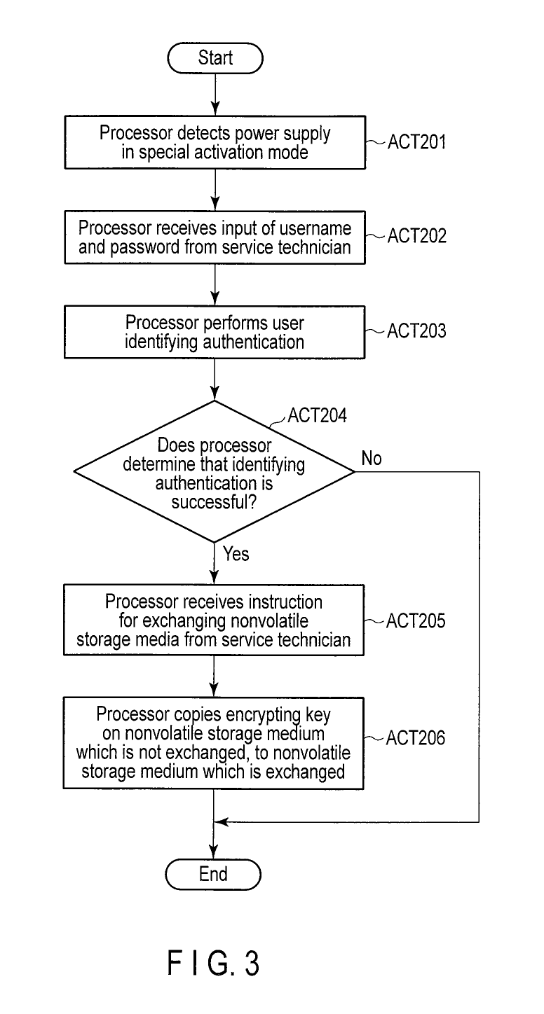

Next, exchange of the FROM 107 (that is, indicates the system board 110 itself where the FROM 107 is installed) or the BB-SRAM 108 due to damage or the like will be described. FIG. 3 is a flowchart illustrating copying of the encrypting key when the FROM 107 (the system board 110) or the BB-SRAM 108 is exchanged. Here, it is assumed that a service technician physically exchanges the FROM 107 (the system board 110) or the BB-SRAM 108 in a state where the image processing apparatus 1 is powered off.

First, the processor 101 detects power supply in a special activation mode (Act 201). Here, the special activation mode is a mode which allows the service technician to perform various kinds of settings. In Act 201, the processor 101 detects the power supply in the special activation mode when the service technician exchanges components, selects the special activation mode from the user interface unit 102, and then supplies power. Next, the processor 101 receives an input of a username and a password from the service technician (Act 202). In Act 202, the processor 101 displays a user authentication screen on the user interface unit 102, and receives the user identifying authentication information such as the username and the password which are input by the service technician. The service technician can input the username and the password from the user interface unit 102.

Next, the processor 101 performs user identifying authentication (Act 203). In Act 203, the processor 101 performs the user identifying authentication through determination of whether or not the username and the password input from the user interface unit 102 correspond with information which is registered in the user information management unit 103 in advance.

Next, the processor 101 determines whether or not the identifying authentication is successful (Act 204). If the processor 101 determines that the identifying authentication is successful (Act 204, Yes), the processor 101 receives an instruction for exchange of nonvolatile storage media from the service technician (Act 205). In Act 205, the processor 101 displays an operation screen for the service technician on the user interface unit 102, and receives the instruction for exchange of nonvolatile storage media from the service technician. For example, the processor 101 receives completion of exchange of the FROM 107 (the system board 110) or exchange of the BB-SRAM 108. Next, the processor 101 copies the encrypting key on the nonvolatile storage medium which is not exchanged to the nonvolatile storage medium which is exchanged for storage (Act 206). In Act 206, for example, if the FROM 107 (the system board 110) is exchanged, the processor 101 copies the encrypting key stored on the BB-SRAM 108 to the FROM 107 for storage. In contrast, if the BB-SRAM 108 is exchanged, the processor 101 copies the encrypting key stored on the FROM 107 to the BB-SRAM 108 for storage. If the processor 101 determines that the identifying authentication is not successful (Act 204, No), the processor 101 finishes the processes.

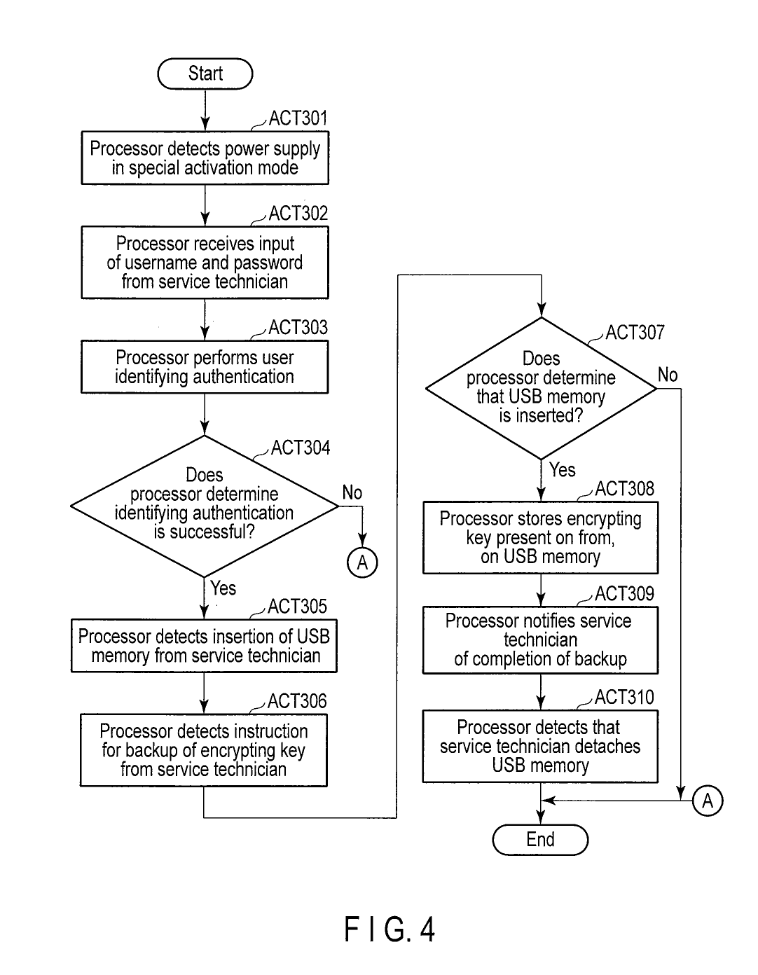

Next, a backup of the encrypting key from the FROM 107 or the BB-SRAM 108 to the USB memory 20 will be described. FIG. 4 is a flowchart illustrating copying of the encrypting key from the FROM 107 to the USB memory 20. In addition, this is also true of the copying of the encrypting key from the BB-SRAM 108 to the USB memory 20, and thus description thereof will be omitted.

First, the processor 101 detects power supply in a special activation mode (Act 301). In Act 301, the processor 101 detects the power supply in the special activation mode when the service technician selects the special activation mode from the user interface unit 102, and then supplies power. Next, the processor 101 receives an input of a username and a password from the service technician (Act 302). In Act 302, the processor 101 displays a user authentication screen on the user interface unit 102, and receives the user identifying authentication information such as the username and the password which are input by the service technician. The service technician can input the username and the password from the user interface unit 102.

Next, the processor 101 performs user identifying authentication (Act 303). In Act 303, the processor 101 performs the user identifying authentication through determination of whether or not the username and the password input from the user interface unit 102 correspond with information which is registered in the user information management unit 103 in advance.

Next, the processor 101 determines whether or not the identifying authentication is successful (Act 304). If the processor 101 determines that the identifying authentication is not successful (Act 304, No), the processor 101 finishes the processes. If the processor 101 determines that the identifying authentication is successful (Act 304, Yes), the processor 101 detects insertion of the USB memory 20 by the service technician (Act 305). In Act 305, the processor 101 displays an operation screen for the service technician on the user interface unit 102, and detects the insertion of the USB memory 20 by the service technician. Next, the processor 101 detects an instruction for a backup of the encrypting key from the service technician (Act 306). In Act 306, the processor 101 detects an instruction for a backup of the encrypting key which is stored on the FROM 107, input from the operation screen by the service technician, to the USB memory 20.

Thereafter, the processor 101 determines whether or not the USB memory 20 is inserted (Act 307). If the processor 101 determines that the USB memory 20 is not inserted into the image processing apparatus 1 (Act 307, No), the processor 101 finishes the processes. If the processor 101 determines that the USB memory 20 is inserted into the image processing apparatus 1 (Act 307, Yes), the processor 101 copies the encrypting key stored on the FROM 107 to the USB memory 20 for storage (Act 308). Next, the processor 101 notifies the service technician of completion of the backup via the user interface unit 102 (Act 309). Then, the processor 101 detects that the service technician detaches the USB memory 20 (Act 310).

Further, the USB memory 20 may embed particular information for authentication used to permit a backup of an encrypting key therein. In this case, if authentication of the USB memory 20 is not performed using the particular information, the processor 101 may not perform the backup of the encrypting key in Act 308.

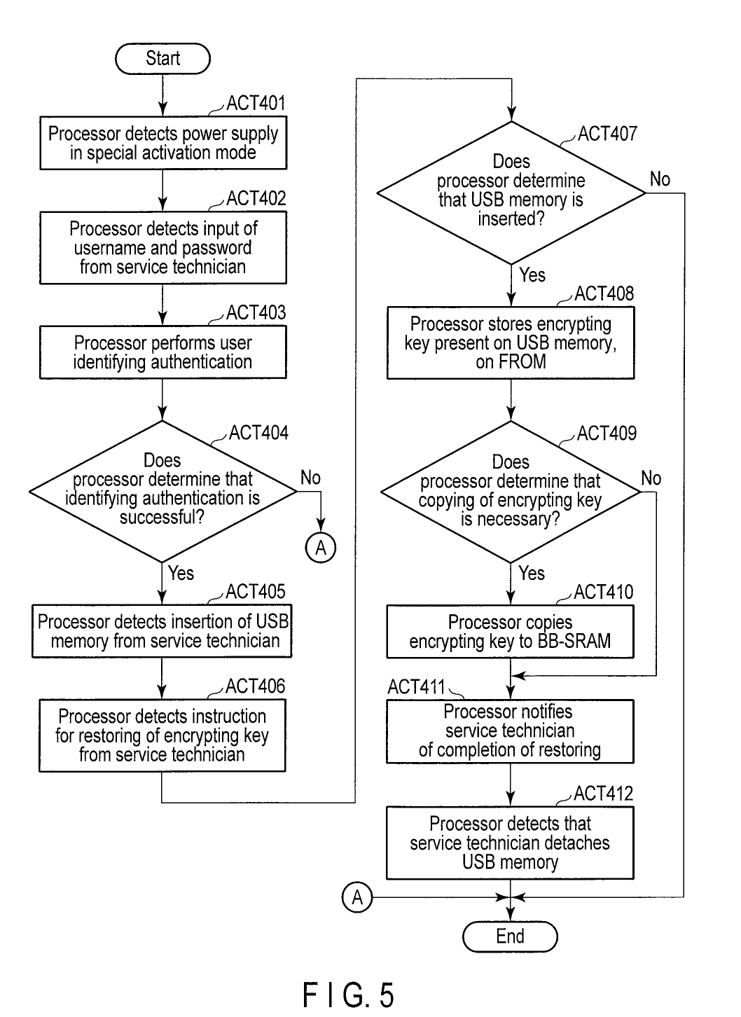

Next, restoring of the encrypting key from the USB memory 20 on at least the FROM 107 will be described. FIG. 5 is a flowchart illustrating restoring of the encrypting key from the USB memory 20 on at least the FROM 107. First, the processor 101 detects power supply in a special activation mode (Act 401). In Act 401, the processor 101 detects the power supply in the special activation mode when the service technician selects the special activation mode from the user interface unit 102, and then supplies power.

Next, the processor 101 receives an input of a username and a password from the service technician (Act 402). In Act 402, the processor 101 displays a user authentication screen on the user interface unit 102, and receives the user identifying authentication information such as the username and the password which are input by the service technician. The service technician can input the username and the password from the user interface unit 102. Next, the processor 101 performs user identifying authentication (Act 403). In Act 403, the processor 101 performs the user identifying authentication through determination of whether or not the username and the password input from the user interface unit 102 correspond with information which is registered in the user information management unit 103 in advance.

Next, the processor 101 determines whether or not the identifying authentication is successful (Act 404). If the processor 101 determines that the identifying authentication is not successful (Act 404, No), the processor 101 finishes the processes. If the processor 101 determines that the identifying authentication is successful (Act 404, Yes), the processor 101 detects insertion of the USB memory 20 by the service technician (Act 405). In Act 405, the processor 101 displays an operation screen for the service technician on the user interface unit 102, and detects the insertion of the USB memory 20 by the service technician.

Next, the processor 101 detects an instruction for restoring of the encrypting key which is stored on the USB memory 20, input from the operation screen by the service technician, on the FROM 107 (Act 406). Thereafter, the processor 101 determines whether or not the USB memory 20 is inserted (Act 407). If the processor 101 determines that the USB memory 20 is not inserted into the image processing apparatus 1 (Act 407, No), the processor 101 finishes the processes. If the processor 101 determines that the USB memory 20 is inserted into the image processing apparatus 1 (Act 407, Yes) the processor 101 moves or copies the encrypting key stored on the USB memory 20 to the FROM 107 for storage (Act 408).

Next, the processor 101 determines whether or not copying of the encrypting key to the BB-SRAM 108 is necessary (Act 409). In Act 409, if the processor 101 determines that, for example, an encrypting key is not stored on the BB-SRAM 108, or an encrypting key stored on the BB-SRAM 108 is different from the encrypting key stored on the FROM 107, the processor 101 determines that the copying of the encrypting key to the BB-SRAM 108 is necessary. If the processor 101 determines that the copying of the encrypting key to the BB-SRAM 108 is necessary (Act 409, Yes), the processor 101 copies the encrypting key stored on either the USB memory 20 or the FROM 107 to the BB-SRAM 108 for storage (Act 410). Next, the processor 101 notifies the service technician of completion of the restoring via the user interface unit 102 (Act 411). Thereafter, the processor 101 detects that the service technician detaches the USB memory 20 (Act 412).

Further, the USB memory 20 may embed particular information for authentication used to permit a backup of an encrypting key therein. In this case, if authentication of the USB memory 20 is not performed using the particular information, the processor 101 may not perform the restoring of the encrypting key in Act 408.

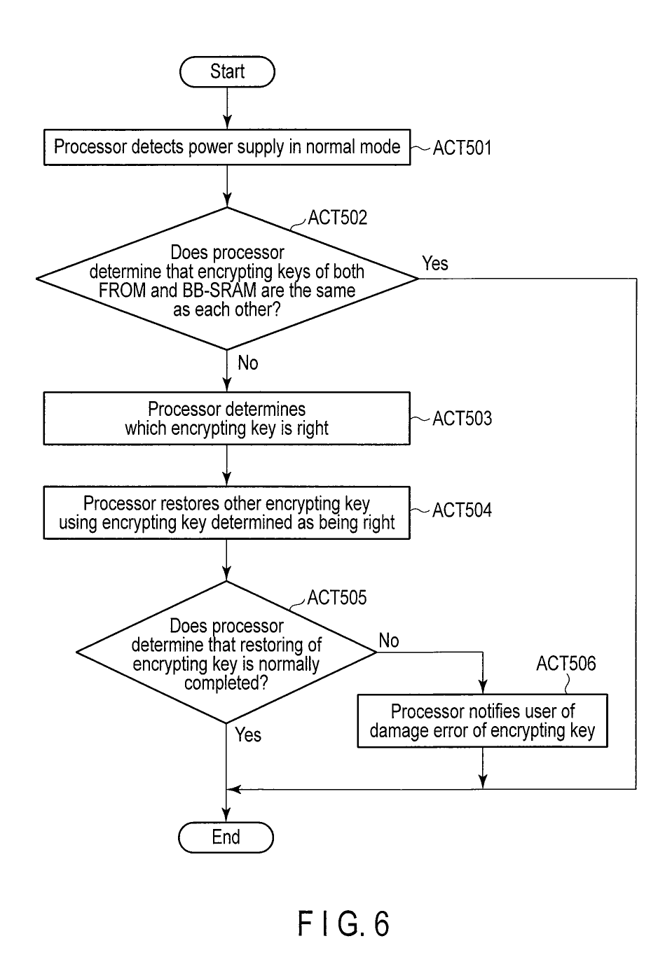

Next, damage detection of the encrypting key stored on the FROM 107 or the BB-SRAM 108 will be described. FIG. 6 is a flowchart illustrating damage detection of the encrypting key stored on the FROM 107 or the BB-SRAM 108. First, the processor 101 detects power supply in a normal mode (Act 501). Here, the normal mode is a mode which allows a general user to perform various kinds of settings. In Act 501, the processor 101 detects the power supply in the normal mode when the general user selects the normal mode from the user interface unit 102, and then supplies power.

Next, the processor 101 determines whether or not both the encrypting key stored on the FROM 107 and the encrypting key stored on the BB-SRAM 108 are the same as each other (Act 502). If the processor 101 determines that both the encrypting key stored on the FROM 107 and the encrypting key stored on the BB-SRAM 108 are the same as each other (Act 502, Yes), the processor 101 finishes the processes.

Next, if the processor 101 determines that the encrypting key stored on the FROM 107 and the encrypting key stored on the BB-SRAM 108 are not the same as each other (Act 502, No), the processor 101 determines which one of the encrypting key stored on the FROM 107 and the encrypting key stored on the BB-SRAM 108 is right (Act 503). In addition, the case where the processor 101 determines that the encrypting key stored on the FROM 107 and the encrypting key stored on the BB-SRAM 108 are not the same as each other in Act 502 is a case where, for example, failure or damage occurs in either the encrypting key stored on the FROM 107 or the encrypting key stored on the BB-SRAM 108. In Act 503, for example, the processor 101 determines the encrypting key where a checksum of binary data of an encrypting key, stored in the encrypting key management unit 104 in advance, is right, as being a right encrypting key.

Next, the processor 101 copies the encrypting key determined as being right to the nonvolatile storage medium storing the other encrypting key (Act 504). Then, the processor 101 determines whether or not restoring of the other encrypting key is normally completed (Act 505). If the processor 101 determines that the restoring of the other encrypting key is normally completed (Act 505, Yes), the processor 101 finishes the processes. If the processor 101 determines that the restoring of the other encrypting key is not normally completed (Act 505, No), the processor 101 notifies the user of damage of the encrypting key via the user interface unit 102 (Act 506). In Act 506, the processor 101 displays occurrences of a damage error in the encrypting key itself of the copy destination on the user interface unit 102.

According to the embodiment, even if failure or damage occurs in a storage medium storing an encrypting key or the encrypting key itself, the encrypting key is stored on other storage media, and thus it is possible to automatically restore the encrypting key. In other words, encrypted image data can be restored (decrypted).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a first nonvolatile storage medium;
a second nonvolatile storage medium;
a generation unit configured to generate an encrypting key for encrypting image data; and
a control unit configured to store the encrypting key on the first nonvolatile storage medium, and store an encrypting key which copies the encrypting key on the second nonvolatile storage medium.

2. The apparatus of claim 1, wherein the generation unit generates the encrypting key stored on the first nonvolatile storage medium when power is supplied for first time.

3. The apparatus of claim 1, wherein the control unit stores a copy of the encrypting key stored on a medium which is not exchanged, on a medium which is exchanged, if either the first nonvolatile storage medium or the second nonvolatile storage medium is exchanged.

4. The apparatus of claim 1, wherein the control unit performs user authentication.

5. The apparatus of claim 4, wherein, after the user authentication is completed, the control unit stores a copy of either the encrypting key stored on the first nonvolatile storage medium or the encrypting key stored on the second nonvolatile storage medium, on a third nonvolatile storage medium which is attachable and detachable to and from the apparatus.

6. The apparatus of claim 5, wherein the control unit stores a copy of the encrypting key stored on the third nonvolatile storage medium on at least one of the first nonvolatile storage medium and the second nonvolatile storage medium.

7. The apparatus of claim 1, wherein the control unit determines whether or not the encrypting key stored on the first nonvolatile storage medium corresponds with the encrypting key stored on the second nonvolatile storage medium.

8. The apparatus of claim 7, wherein the control unit determines which one is right if determining that the encrypting key stored on the first nonvolatile storage medium does not correspond with the encrypting key stored on the second nonvolatile storage medium.

9. The apparatus of claim 8, wherein the control unit restores an encrypting key which is determined as not being right using an encrypting key which is determined as being right.

10. The apparatus of claim 1, wherein the first nonvolatile storage medium is a fixed nonvolatile storage medium, and the second nonvolatile storage medium is a semi-fixed nonvolatile storage medium.

11. An image processing method comprising:
generating an encrypting key for encrypting image data; and
storing the encrypting key on a first nonvolatile storage medium, and storing an encrypting key which copies the encrypting key on a second nonvolatile storage medium.

12. The method of claim 11, comprising:
generating the encrypting key stored on the first nonvolatile storage medium when power is supplied for the first time.

13. The method of claim 11, comprising:
storing a copy of the encrypting key stored on a medium which is not exchanged, on a medium which is exchanged, if either the first nonvolatile storage medium or the second nonvolatile storage medium is exchanged.

14. The method of claim 11, comprising:
performing user authentication based on a user input.

15. The method of claim 14, comprising:
storing a copy of either the encrypting key stored on the first nonvolatile storage medium or the encrypting key stored on the second nonvolatile storage medium, on a third nonvolatile storage medium which is attachable and detachable to and from the apparatus, after the user authentication is completed.

16. The method of claim 15, comprising:
storing a copy of the encrypting key stored on the third nonvolatile storage medium on at least one of the first nonvolatile storage medium and the second nonvolatile storage medium.

17. The method of claim 11, comprising:
determining whether or not the encrypting key stored on the first nonvolatile storage medium corresponds with the encrypting key stored on the second nonvolatile storage medium.

18. The method of claim 17, comprising:
determining which one is right if determining that the encrypting key stored on the first nonvolatile storage medium does not correspond with the encrypting key stored on the second nonvolatile storage medium.

19. The method of claim 18, comprising:
restoring an encrypting key which is determined as not being right using an encrypting key which is determined as being right.

20. The method of claim 11, wherein the first nonvolatile storage medium is a fixed nonvolatile storage medium, and the second nonvolatile storage medium is a semi-fixed nonvolatile storage medium.
